(19) United States
(12) Patent Application Publication
(10) Pub. No.: US 2011/0143820 A1
(43) Pub. Date: Jun. 16, 2011

(54) HEADPHONES WITH ATTACHED MICROPHONE BOOM

(76) Inventor: Robert Heil, Belleville, IL (US)

(21) Appl. No.: 12/636,307

(22) Filed: Dec. 11, 2009

(51) Int. Cl. H04M 1/00

(52) U.S. Cl. 455/569.1

(57) ABSTRACT

A headphone assembly includes a pair of earpieces, each for engagement over one ear of a user. The earpieces are coupled to ends of an arcuate headband adapted for wear on the user's head. A microphone boom for holding a microphone is retained to one of the earpieces by a housing having mating upper and lower gaskets. The gaskets have notches for retaining the microphone boom within the gaskets.

### FIELD OF THE INVENTION

This invention relates generally to the fields of headphones and microphones.

### BACKGROUND OF THE INVENTION

In many instances, broadcasters, radio professionals, telephone operators, amateur radio enthusiasts and others have a need to use both headphones and a microphone simultaneously. Prior headphones that incorporated microphones suffered from several drawbacks including lack of comfort and microphone articulation. A need exists, therefore, for an improved headphone set that incorporates a proper microphone boom.

### SUMMARY OF THE INVENTION

According to one aspect of the present invention, a headphone assembly includes a pair of earpieces, each for engagement over one ear of a user. The earpieces are coupled to ends of an arcuate headband adapted for wear on the user's head. A microphone boom for holding a microphone is retained to one of the earpieces by a housing having mating upper and lower gaskets. Preferably, the gaskets have notches for retaining the microphone boom within the gaskets.

In other embodiments, one of the earpieces of the headphone assembly of may include a port having a screw insert mounted therein wherein the housing is attached to the screw insert. A thumb screw may then be inserted through the upper and lower gaskets and into the screw insert in the earpiece to retain the housing and to permit the user to rotate the microphone boom.

### BRIEF DESCRIPTION OF THE FIGURES

These and other features, aspects and advantages of the invention will become more fully apparent from the following detailed description, appended claims, and accompanying drawings, wherein the drawings illustrate features in accordance with an exemplary embodiment of the present invention, and wherein:

FIG. 1 is an illustration of the headphone assembly in accordance with one embodiment of the present invention;

FIG. 2 is a exploded view of the housing of the headphone assembly;

FIG. 3 is another exploded view of the housing of the headphone assembly;

FIG. 4 is a perspective view of the headphone assembly illustrating the screw insert for the microphone boom; and

FIG. 5 is a perspective view of the earpiece of the headphone assembly illustrating a rubber plug inserted into the port.

### DETAILED DESCRIPTION OF THE INVENTION

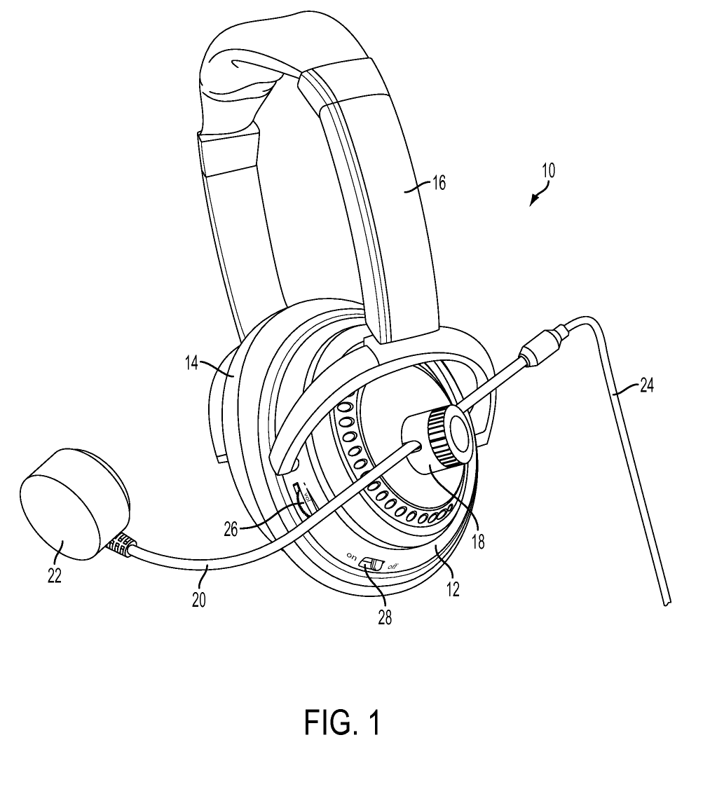

FIG. 1 illustrates a headphone assembly 10 adapted for engagement over the ears of a user. The headphone assembly 10 includes two earpieces 12 and 14, each coupled to an arcuate headband 16 that is designed for wear on a user's head. The headphone assembly 10 also includes a housing 18 for attaching a microphone boom 20 coupled to a microphone 22. The microphone boom 20 is connected to a microphone jack 24 for attachment to other conventional communication or sound equipment. The headphone assembly may also include an on/off button 28 and a volume control switch 26.

The headphone assembly 10 may include active noise reduction circuitry mounted in one or both of the earpieces 12 and 14. Such circuitry may actively reduce the noise generated outside the headphone assembly 10 from reaching the user's eardrum. Conventional noise reduction circuitry is well known to those skilled in the art and generally includes means for sensing noise that originates from sources outside the headphone assembly 10 and means for generating a compensating sound to the outside noise and means for supplying the compensating sound to the user for canceling at least some of the outside noise.

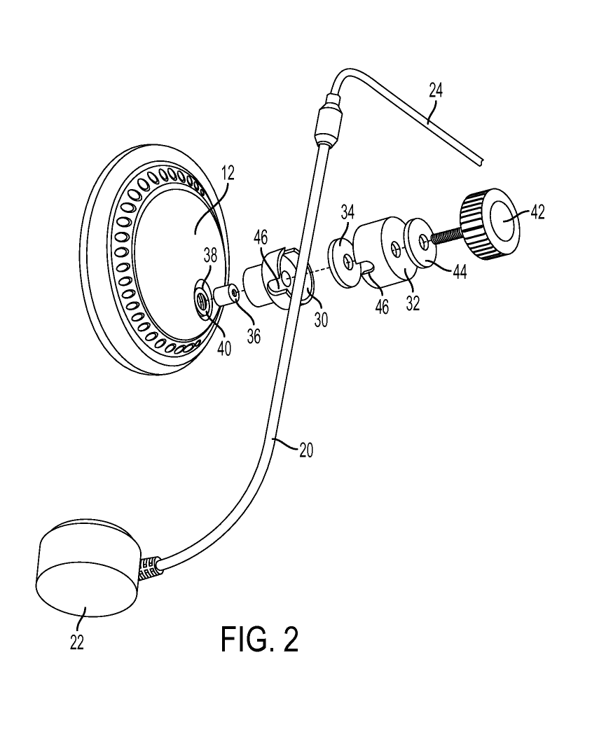

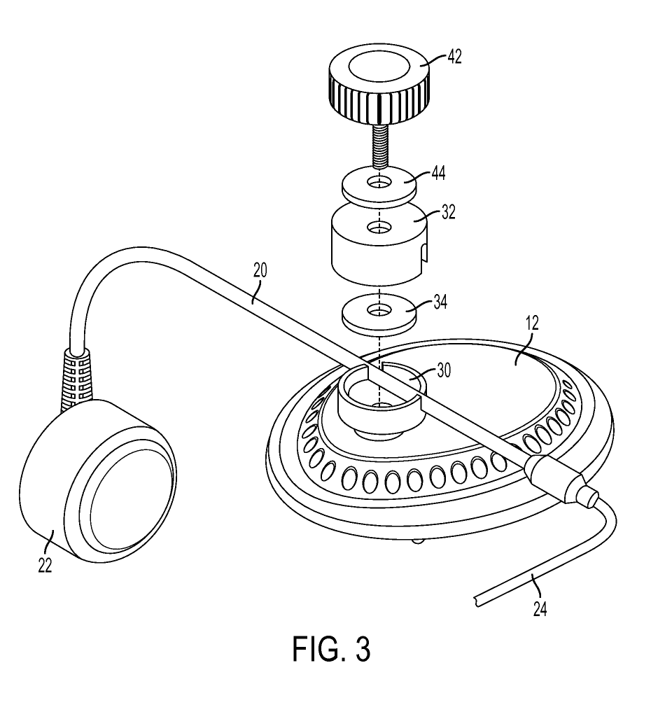

As illustrated in FIGS. 2 and 3, the housing 18 includes a lower gasket 30 which mates with upper gasket 32 to retain the microphone boom 20. Each of the lower and upper gaskets 30 and 32 preferably include notches 46 shaped to mate with the outer circular surface of the microphone boom 20. The lower gasket 30 may be smaller in diameter than the upper gasket 32 such that the upper gasket 32 fits over the lower gasket 30. A washer 34, which may be a fiber or other suitable washer, may be included between the upper or lower gasket 30 or 32 to assist in retaining the microphone boom 20 in place. A thumb screw 42 is inserted into a screw opening in the upper gasket 32 to retain the housing 18 and to permit the user to rotate the microphone boom 20. A second washer 44 may be placed between the upper gasket 32 and the thumb screw 42. Preferably, the notches 46 are offset from the centerline of the gaskets 30 and 32 to afford the thumb screw 42 an opportunity to pass through the center of the gaskets 30 and 32 to retain the microphone boom 20.

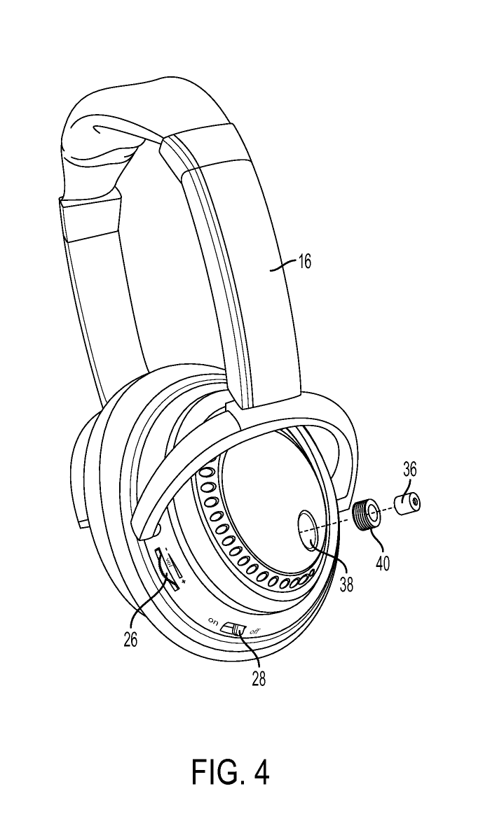

FIG. 4 illustrates one means for attaching the housing 18 to an earpiece 12. Earpiece 12 includes a hollow, preferably circular, port 38 into which a screw insert 40 (preferably brass) is placed. The insert 40 may be molded into the port 38 of the earpiece 12, glued in, or attached by other conventional means. The screw insert 40 has a threaded internal opening designed to threadedly engage with the thumb screw 42 and a smooth outer surface designed to engage with an opening in the proximal end of the lower gasket 30. The lower gasket 30 of the housing 18 is then rotationally attached to the screw insert 40 to allow the microphone boom 20 to swivel. Thus, the thumb screw 42 is screwed into the screw insert 40 to retain the housing to the earpiece 12. The proximal end of the lower gasket 30 fits onto the outside surface of the screw insert 40. A guide 36 may be used to provide support and to fill in space between the inner surface of the lower end of the lower gasket 30 and the outer surface of the screw insert 40. Although FIG. 4 illustrates the opening 38 and screw insert 40 on only one earpiece, such an port 38 and insert 40 may be included on one or both of the earpieces to allow the user to located the microphone boom 20 on either earpiece 12 or 14.

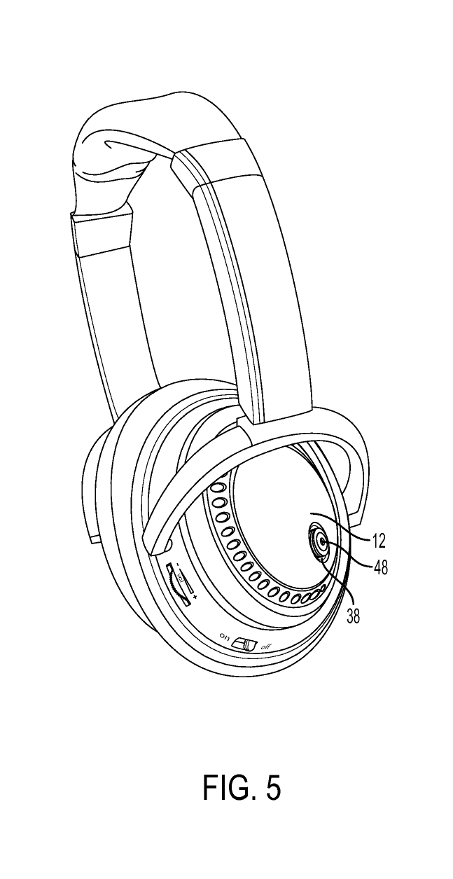

As illustrated in FIG. 5, the headphone assembly 10 may further include a rubber plug 48 inserted into the port 38 of an earpiece 12 when the user desires to use the headphones without the accompanying microphone.

A variety of detachable booms with various microphones may be used, including these specifically designed for ham radio, broadcast radio, and interfacing with computers. In the event the booms vary in outer diameter (either in shape or size), the gaskets 30 and 32 may be changed to accommodate these other booms. Thus, the headphone assembly may come in a kit that includes a number of microphone booms and associated gaskets, all designed to work with the same headphones.

Although certain illustrative embodiments and methods have been disclosed herein, it will be apparent from the foregoing disclosure to those skilled in the art that variations and modifications of such embodiments and methods may be made without departing from the spirit and scope of the invention. Accordingly, it is intended that the invention should be limited only to extent required by the appended claims and the rules and principals of applicable law.

1. A headphone assembly comprising:
a pair of earpieces, each for engagement over one ear of a user;
an arcuate headband adapted for wear on the user's head and having a pair of opposite ends, wherein one of the earpieces is coupled to one of the ends of the headband and the other earpiece is coupled to the other of the ends of the headband;
a microphone boom for holding a microphone; and
a housing for attaching the microphone boom to the headphone assembly, the housing comprising mating upper and lower gaskets having notches for retaining the microphone boom within the gaskets.

2. The headphone assembly of claim 1 wherein at least one of the earpieces comprise a port having a screw insert mounted therein and wherein the housing is attached to the screw insert.

3. The headphone assembly of claim 2 further comprising a thumb screw inserted through the upper and lower gaskets and into the screw insert in the earpiece to retain the housing and to permit the user to rotate the microphone boom.

4. The headphone assembly of claim 2 wherein the housing is rotationally attached to the screw insert.

5. The headphone assembly of claim 4 wherein the screw insert has a smooth outer surface designed to engage with an opening in a proximal end of the lower gasket such that the housing is rotationally attached to the screw insert to allow the microphone boom to swivel.

6. The headphone assembly of claim 1 wherein the lower gasket is smaller in diameter than the upper gasket such that the upper gasket fits over the lower gasket.

7. The headphone assembly of claim 3 wherein the notches of the gaskets are offset from a centerline of the gaskets to afford the thumb screw an opportunity to pass through the center of the gaskets to retain the microphone boom.

8. The headphone assembly of claim 1 wherein the earpieces have active noise reduction circuitry for actively reducing noise generated outside the headphone assembly from reaching the user.
